(19) United States
(12) Patent Application Publication
(10) Pub. No.: US 2025/0264729 A1
(43) Pub. Date: Aug. 21, 2025

(54) LASER PROJECTOR

(71) Applicant: DELTA ELECTRONICS, INC., Taoyuan City (TW)

(72) Inventor: Hung-Ying LIN, Taoyuan City (TW)

(21) Appl. No.: 18/815,815

(22) Filed: Aug. 26, 2024

(30) Foreign Application Priority Data
Feb. 21, 2024 (CN) 202410191035.1

(51) Int. Cl. G02B 27/48; G02B 27/20

(52) U.S. Cl. CPC G02B 27/48; G02B 27/20

(57) ABSTRACT

A laser projector includes a laser light source configured to emit a laser light, a homogenizer configured to receive the laser light, a first diffusion element located between the laser light and the homogenizer, and a second diffusion element located between the laser light source and the homogenizer. The first diffusion element and the second diffusion element are different type.

### CROSS-REFERENCE TO RELATED APPLICATION

This application claims priority to China Application Serial Number 202410191035.1, filed Feb. 21, 2024, which is herein incorporated by reference in its entirety.

### BACKGROUND

### Field of Invention

The present invention relates to a laser projector.

### Description of Related Art

Projectors which use pure lasers as light source have speckles on the display screen due to high coherence of the laser light. The ways to eliminate speckles involve the use of incoherent light, diffusion element, optical fiber, or shaking the screen. However, those methods above increase the Étendue of the projection system and cause a trade-off between the contrast and efficiency of the projection system. Without losing contrast or efficiency, the effect of speckle elimination is limited. Therefore, it is difficult to eliminate speckles while simultaneously maintaining high contrast and efficiency.

Accordingly, it is still a development direction for the industry to provide a laser projector that can solve the problems above.

### SUMMARY

One aspect of the present disclosure is a laser projector.

In one embodiment, the laser projector includes a laser light source configured to emit a laser light, a homogenizer configured to receive the laser light, a first diffusion element located between the laser light and the homogenizer, and a second diffusion element located between the laser light source and the homogenizer. The first diffusion element and the second diffusion element are different type.

In one embodiment, the first diffusion element is a static diffusion system configured to shape the laser light.

In one embodiment, the second diffusion element is a dynamic diffusion element configured to eliminate speckles.

In one embodiment, the laser projector further includes a condenser lens located between the first diffusion element and the second diffusion element and configured to converge the laser light.

In one embodiment, the laser projector further includes a shrinking element located between the condenser lens and the second diffusion element. The shrinking element is configured to make the converging laser light become a parallel light and reduce a cross-sectional area of the laser light.

In one embodiment, the laser projector further includes a first light transmitting element located between the second diffusion element and the homogenizer. The first light transmitting element is configured to maintain an Étendue of the laser light and make the laser light adapted to the homogenizer.

In one embodiment, the homogenizer is a light tunnel.

In one embodiment, the homogenizer is a lens array.

In one embodiment, the laser projector further includes a second transmitting element located between the first transmitting element and the homogenizer. The second transmitting element is configured to maintain the Étendue of the laser light and allocate the laser light to the lens array.

Another aspect of the present disclosure is a laser projector.

In one embodiment, the laser projector includes a laser light source configured to emit a laser light, a homogenizer configured to receive the laser light, a light shrinking lens group, and a diffusion element located between the light shrinking lens group and the homogenizer. The light shrinking lens group includes a shrinking element configured to make the laser light become a parallel light, a condenser lens configured to converge the laser light. The condenser lens is located between the laser light source and the shrinking element.

In one embodiment, the diffusion element includes a dynamic diffusion element configured to eliminate speckles.

In one embodiment, the laser projector includes a static diffusion system located between the laser light source and the light shrinking lens group.

In one embodiment, the laser projector further includes a light transmitting lens group located between the diffusion element and the homogenizer. The light transmitting lens group is configured to maintain an Étendue of the laser light.

In one embodiment, the light transmitting lens group includes a first light transmitting element configured to make the laser light converge and a second light transmitting element located between the first light transmitting element and the homogenizer. The second light transmitting element is configured to allocate the laser light to the homogenizer.

In one embodiment, the homogenizer is a lens array.

In one embodiment, the homogenizer is a light tunnel.

In the aforementioned embodiment, the laser projector of the present disclosure can eliminate speckles and adapt the laser lights to the homogenizer through the first diffusion element and the second diffusion element. The speckle elimination effect provided by the second diffusion element can be unlimited by using the shrinking lens group. The laser lights are adapted to the homogenizer through the light transmitting lens group. Therefore, the laser projector disclosed in the present disclosure can simultaneously have high efficiency, high contrast and good speckle noise reduction effect.

### BRIEF DESCRIPTION OF THE DRAWINGS

The invention can be more fully understood by reading the following detailed description of the embodiment, with reference made to the accompanying drawings as follows:

FIG. 1 is a schematic of a laser projector according to one embodiment of the present disclosure.

FIG. 2 is a schematic of a light path of the laser projector in FIG. 1.

FIG. 3 is a schematic of a laser projector according to another embodiment of the present disclosure.

FIG. 4 is a schematic of a light path of the laser projector in FIG. 3.

FIG. 5 is a schematic of a laser projector according to another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

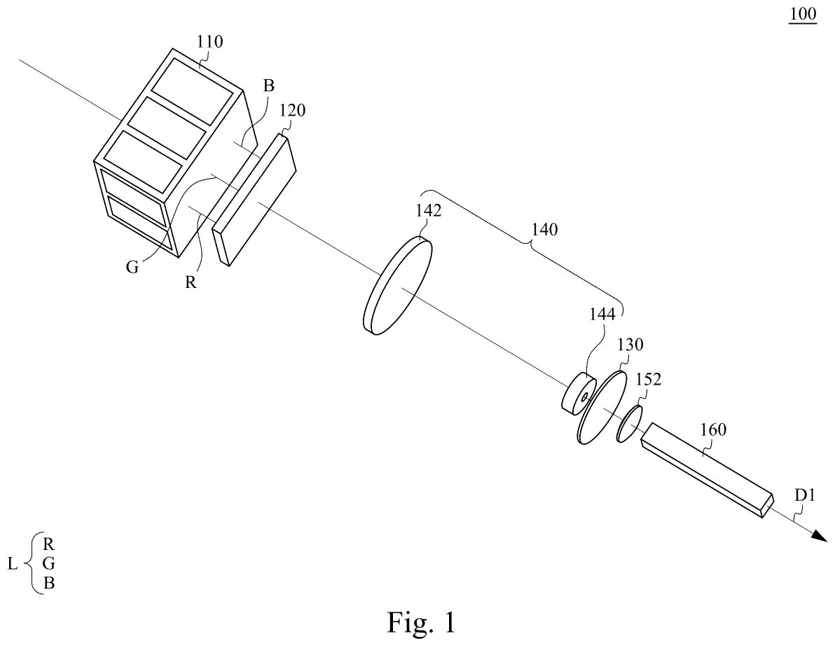

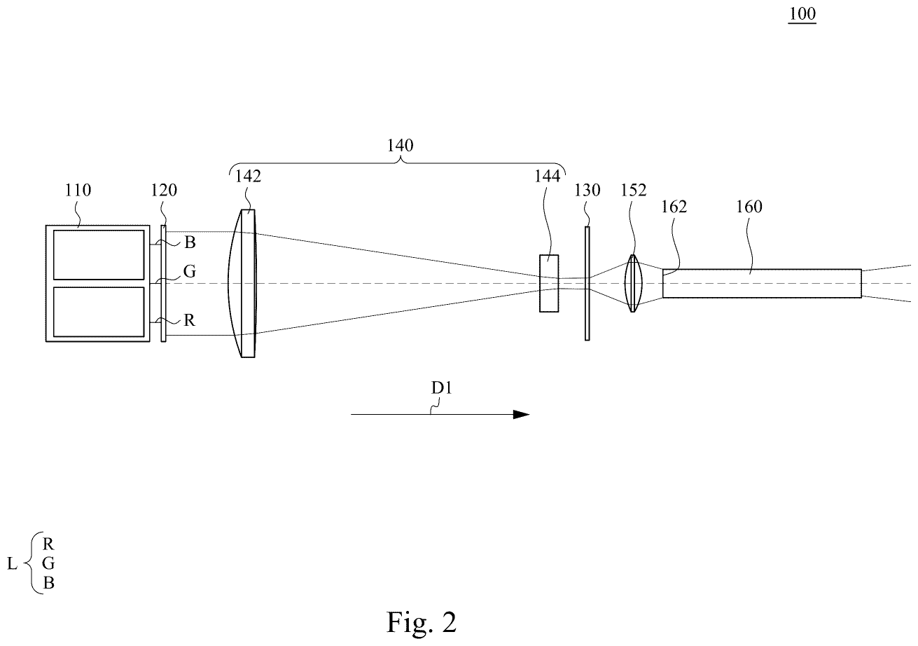

FIG. 1 is a schematic of a laser projector 100 according to one embodiment of the present disclosure. FIG. 2 is a schematic of a light path of the laser projector 100 in FIG. 1. The laser projector 100 includes a laser light source 110, a first diffusion element 120, and a second diffusion element 130, and a shrinking lens group 140, a first light transmitting element 152, and a homogenizer 160 sequentially arranged along an optical axis direction D1. The laser light source 110 is configured to emit multiple laser lights L such as a red light R, a blue light B, and a green light G. The first diffusion element 120 is located between the laser light source 110 and the homogenizer 160. The second diffusion element 130 is located between the homogenizer 160 and the first diffusion element 120. The homogenizer 160 has a light incident surface 162 configured to receive the laser lights L passing the first diffusion element 120 and the second diffusion element 130.

Since the laser lights L are high collimated beams, the red light R, the blue light B and the green light G emitted by the laser light source 110 are somewhat separated among each other and cannot fill the light incident surface 162 of the homogenizer 160. The high coherence of laser lights L causes speckles to appear on the projection screen.

Étendue is defined as the integral of a cross-sectional area of the laser lights L and the beam solid angle: Étendue=πS NA², where S is the beam cross-sectional area and πNA² is the beam solid angle. In an ideal optical system that does not consider energy losses (such as scattering, absorption, etc.), the Étendue should be conserved.

The first diffusion element 120 is a static diffusion system that is configured to shape the laser lights L to fit the profile of the light incident surface 162 of the homogenizer 160. After the laser lights L passes through the second diffusion element 130, the red light R, the blue light B, and the green light G are diffused and adapted to the light incident surface 162 of the homogenizer 160. In other words, the cross-sectional area of the diffused laser lights L can match the light incident surface 162.

The second diffusion element 130 is a dynamic diffusion element configured to eliminate speckles. The dynamic diffusion element includes a diffuser and an actuator. The actuator can move or shake the diffuser in a direction perpendicular to the optical axis direction. The dynamic diffusion element may include coating or rough surface that used to disrupt the phase of the laser lights L.

The first diffusion element 120 and the second diffusion element 130 are used to eliminate speckles, but increase the Étendue of the laser projector 100. Under this situation, a larger aperture is required in such optical system of which the Étendue is increased to maintain the efficiency of the laser projector 100. As a result, the contrast of the laser projector 100 will be reduced.

For example, when the second diffusion element 130 is placed in an optical system, the laser lights L increase their scattering angle (the solid angle increases) after passing through the second diffusion element 130. The light receiving element behind the second diffusion element 130 placed in the optical system (along the optical axis direction D1 in FIG. 1) cannot completely receive the laser lights L, which decreases the efficiency. Therefore, it is difficult to eliminate speckles yet have high efficiency and high contrast at the same time.

Generally speaking, if the cross-sectional area of the laser lights L entering the second diffusion element 130 is greater, the homogenizer 160 is more unlikely to fully receive and transmit the laser lights L that pass through the second diffusion element 130 to the rear imaging element (such as digital micro-reflective chip, DMD). Therefore, the scattering angle provided by the second diffusion element 130 is limited, and the speckle reduction effect is not satisfactory. Alternatively, without limiting the scattering angle of the second diffusion element 130, an imaging element with a large aperture is required to completely receive the diffused laser lights L. As a result, the contrast of the laser projector 100 will be reduced.

The shrinking lens group 140 includes a condenser lens 142 and a shrinking element 144. The condenser lens 142 is located between the first diffusion element 120 and the second diffusion element 130 and is configured to converge the laser lights L. The shrinking element 144 is located between the condenser lens 142 and the second diffusion element 130 and is configured to make the laser lights L become a parallel light and reduce a cross-sectional area of the laser lights L. In such arrangement, the scattering angle of the shrunk parallel light passing through the second diffusion element 130 is smaller than the scattering angle of a converged oblique light (for example, being a focus spot on the second diffusion element 130) after incident on the second diffusion element 130.

The configuration of the aforementioned first diffusion element 120 (static diffusion system), the shrinking lens group 140, and the second diffusion element 130 (dynamic diffusion element) is beneficial to provide better speckle reduction effect. Specifically, the cross-sectional area of the laser lights L entering the second diffusion element 130 can be small through the first diffusion element 120 and the shrinking lens group 140, and therefore the second diffusion element 130 with large scattering angle can be used to provide better speckle elimination effect. In other words, the scattering angle of the second diffusion element 130 is not limited, and there is no need to use a large aperture, which will not reduce the contrast of the laser projector.

The laser projector 100 includes a first light transmitting element 152 located between the second diffusion element 130 and the homogenizer 160. The first light transmitting element 152 is configured to maintain the Étendue of the laser lights L. For example, the homogenizer 160 of the present disclosure is a light tunnel. The first diffusion element 120 is configured to shape the laser lights L to fit the rectangular shaped entry of the light tunnel. The scattering angle of the laser lights L increases after the laser lights L pass through the second diffusion element 130, and the first light transmitting element 152 can fully receive the laser lights L passing through the second diffusion element 130. Then the first light transmitting element 152 may make the laser lights L converge and adapt the laser lights L to the homogenizer 160. The first light transmitting element 152 can adjust the scattering angle and the cross-section area of the laser lights L such that the homogenizer 160 can fully receive the laser light L. Therefore, the laser projector 100 of the present disclosure has high efficiency, high contrast and good speckle elimination and noise reduction effect.

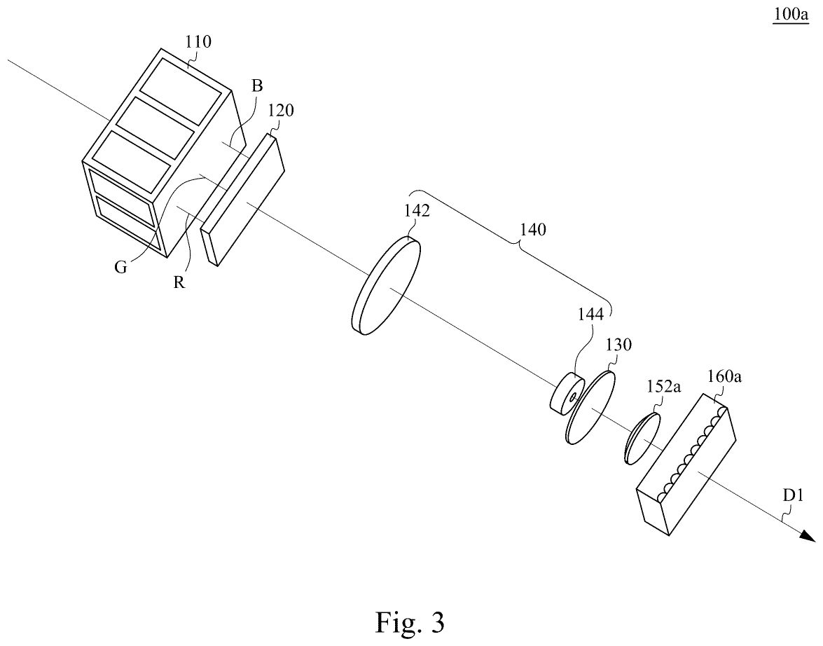

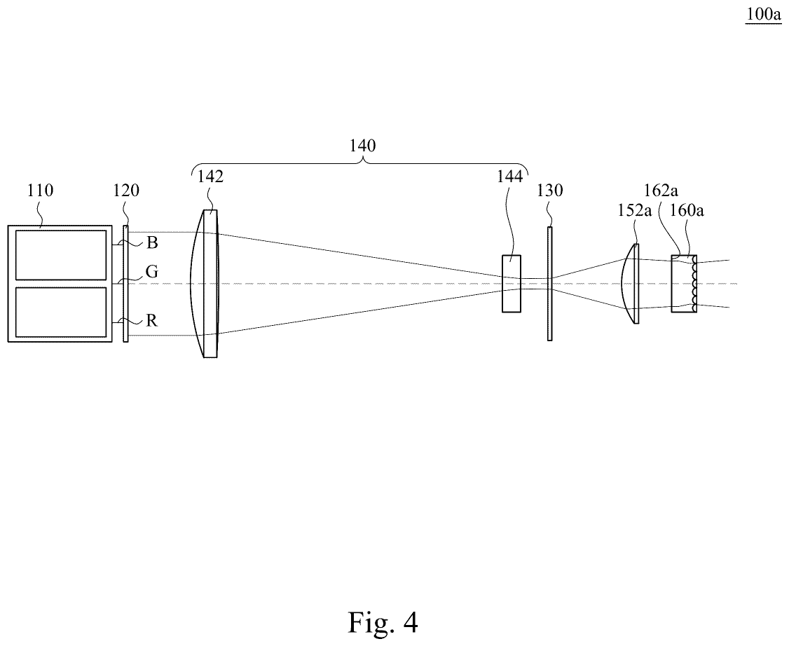

FIG. 3 is a schematic of a laser projector 100a according to another embodiment of the present disclosure. FIG. 4 is a schematic of a light path of the laser projector 100a in FIG. 3. The laser projector 100a is similar to the laser projector 100 in FIG. 1, and the difference is that the homogenizer 160a of the laser projector 100a is a lens array. The first light transmitting element 152a of the laser projector 100a is configured to maintain the Étendue of the laser lights L. The solid angle of the laser lights L after passing through the second diffusion element 130 increases, and the first light transmitting element 152a can completely receive the laser lights L passing through the second diffusion element 130. The first light transmitting element 152a may make the laser lights L converge and adapt the laser lights L to the homogenizer 160a. The laser projector 100a and the laser projector 100 have the same advantages, which will not be described again.

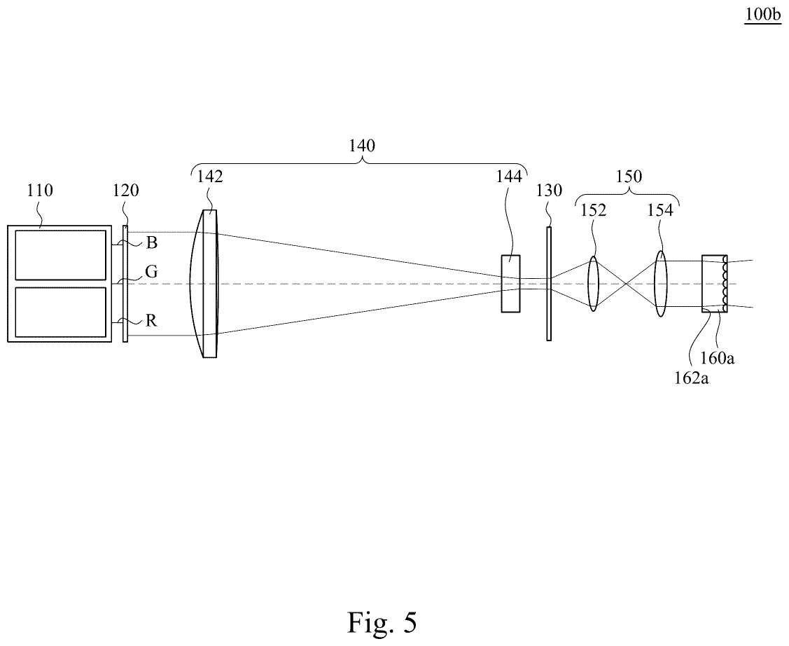

FIG. 5 is a schematic of a laser projector 100b according to another embodiment of the present disclosure. The laser projector 100b is similar to the laser projector 100a, and the difference is that the laser projector 100b further includes a second light transmitting element 154. The second light transmitting element 154 is located between the first light transmitting element 152a and the homogenizer 160a. The second light transmitting element 154 is configured to maintain the etendue of the laser lights L. The first light transmitting element 152 and the second light transmitting element 154 are configured as a light transmitting lens group 150. In other embodiments, the light transmitting lens group 150 may have more than two elements.

In the present embodiment, the laser lights L are converged through the first light transmitting element 152a. The second light transmitting element 154 adjusts the laser lights L to be close to parallel lights, such that the laser lights L can enter the homogenizer 160a with a suitable cross-sectional area and solid angle for the light incident surface 162a of the homogenizer 160a. The second light transmitting element 154d is configured to allocate the parallel laser lights L to the lens array. The laser projector 100b and the laser projector 100a have the same advantages, which will not be described again.

In summary, the laser projector of the present disclosure can eliminate speckles and adapt the laser lights to the homogenizer through the first diffusion element and the second diffusion element. The speckle elimination effect provided by the second diffusion element can be unlimited by using the shrinking lens group. The laser lights are adapted to the homogenizer through the light transmitting lens group. Therefore, the laser projector disclosed in the present disclosure can simultaneously have high efficiency, high contrast and good speckle noise reduction effect.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A laser projector, comprising:
a laser light source configured to emit a laser light;
a homogenizer configured to receive the laser light;
a first diffusion element located between the laser light and the homogenizer; and
a second diffusion element located between the laser light source and the homogenizer, wherein the first diffusion element and the second diffusion element are different types.

2. The laser projector of claim 1, wherein the first diffusion element is a static diffusion system configured to shape the laser light.

3. The laser projector of claim 1, wherein the second diffusion element is a dynamic diffusion element configured to eliminate speckles.

4. The laser projector of claim 1, further comprising:
a condenser lens located between the first diffusion element and the second diffusion element and configured to converge the laser light.

5. The laser projector of claim 4, further comprising:
a shrinking element located between the condenser lens and the second diffusion element, wherein the shrinking element is configured to make the converging laser light become a parallel light and reduce a cross-sectional area of the laser light.

6. The laser projector of claim 1, further comprising:
a first light transmitting element located between the second diffusion element and the homogenizer, wherein the first light transmitting element is configured to maintain an etendue of the laser light and make the laser light adapted to the homogenizer.

7. The laser projector of claim 6, wherein the homogenizer is a light tunnel.

8. The laser projector of claim 6, wherein the homogenizer is a lens array.

9. The laser projector of claim 8, further comprising:
a second transmitting element located between the first transmitting element and the homogenizer, wherein the second transmitting element is configured to maintain the etendue of the laser light and allocate the laser light to the lens array.

10. A laser projector comprising:
a laser light source configured to emit a laser light;
a homogenizer configured to receive the laser light;
a light shrinking lens group, comprising:
a shrinking element configured to make the laser light become a parallel light; and
a condenser lens configured to converge the laser light, wherein the condenser lens is located between the laser light source and the shrinking element; and
a diffusion element located between the light shrinking lens group and the homogenizer.

11. The laser projector of claim 10, wherein the diffusion element comprises a dynamic diffusion element configured to eliminate speckles.

12. The laser projector of claim 10, further comprising a static diffusion system located between the laser light source and the light shrinking lens group.

13. The laser projector of claim 10, further comprising:
a light transmitting lens group located between the diffusion element and the homogenizer, wherein the light transmitting lens group is configured to maintain an etendue of the laser light.

14. The laser projector of claim 13, wherein the light transmitting lens group comprises:
a first light transmitting element configured to make the laser light converge; and
a second light transmitting element located between the first light transmitting element and the homogenizer, wherein the second light transmitting element is configured to allocate the laser light to the homogenizer.

15. The laser projector of claim 14, wherein the homogenizer is a lens array.

16. The laser projector of claim 10, wherein the homogenizer is a light tunnel.
